(19) United States
(12) Patent Application Publication
(10) Pub. No.: US 2025/0104134 A1
(43) Pub. Date: Mar. 27, 2025

(54) System, Method, and Apparatus for Viewing and Selecting Wearable Objects

(71) Applicant: Hector Zuniga, Bradenton, FL (US)

(72) Inventor: Hector Zuniga, Bradenton, FL (US)

(21) Appl. No.: 18/472,467

(22) Filed: Sep. 22, 2023

(51) Int. Cl. G06Q 30/0601; G06T 17/20

(52) U.S. Cl. CPC G06Q 30/0643; G06Q 30/0623; G06T 17/20

(57) ABSTRACT

A system for viewing and selecting wearable objects (e.g., fashion) starts with a base image of the user, capturing the physique and build of the user. Later, when the user finds a fashion that interests the user, the user captures an image of the fashion (e.g., on another person, in a store display, on the television, on a mannequin, etc.), and the system for viewing and selecting wearable objects superimposes the fashion on the base image of the user, adjusting for differences in physique and build between the image of the fashion and the base image of the user. Now the user is able to see what they will look like wearing the fashion and will be presented with a bill of materials that comprise the fashion and links for purchasing each item in the fashion.

### BACKGROUND OF THE INVENTION

Finding the right fashion for a person isn't easy. There exists a huge variety of clothing and accessories in various sizes and colors from countless manufacturers, retailers, on-line suppliers, etc. How does one find the right clothing, accessories, shoes, scarves, hats, even watches?

Today, one way to find suitable fashion (e.g., clothing, accessories, shoes, scarves, hats) is to visit a retail store, wander through racks and racks of fashion items, and when you find something that you like, go into a fitting room to try on that fashion item. This way of finding fashion works in a limited way, as the person is limited to only the fashion items available in that retail establishment and the person is not able to see how a certain fashion item goes with another fashion item from another retailer.

Another way to find fashion is by shopping online. In this, the user visits one or more retailers and browses countless pages of fashion, maybe narrowing the choice using filters such as “denim shorts.” Even if the user is able to find something that they like, the user does not really know what this particular fashion item will look like. Not until they eventually receive their package and try on this fashion item. Furthermore, it is difficult to know what one item from one retailer will look like matched with another item from a different retailer, or even from the same retailer. The user is then faced with ordering an item of fashion, having the item delivered in a few days, trying on this item, and returning this item if it does not look good on the user. Although most retailers allow for safe, no-cost shipping and returns, the user still has unneeded or undesired activity on their credit cards and often the user worries that the purchase will not be refunded properly.

Many times, you will see someone wearing an outfit that looks great on that person, possibly on the television, an advertisement, a magazine, or walking down the street. You might want to recreate that exact look (fashion), but there are several obstacles. First, will that look be right for you? Maybe the person wearing the outfit (fashion) is thinner, taller, heavier, shorter, has different skin tone, has different hair style/color, etc. The same outfit might not work for your physique. Next, it may be difficult to find each component of the look/fashion (fashion items). The shirt came from one retailer, the tie or scarf from another, the jacket from still another, the paints/skirt from another, the shoes and belt came from Italy, etc. How is one to find retailers of all the different components of this look/fashion? Even if you are only interested in the shirt, where do you find that shirt?

What is needed is a system that will allow a user to be able to see what they will look like in a particular fashion and provide a way to purchase the component items of the fashion.

### SUMMARY OF THE INVENTION

The system for viewing and selecting wearable objects (e.g., fashion) starts with a base image of the user, capturing the physique and build of the user. Later, when the user finds a fashion that interests the user, the user captures an image of the fashion (e.g., on another person, in a store display, on the television, on a mannequin, etc.), and the system for viewing and selecting wearable objects superimposes the fashion on the base image of the user, adjusting for differences in physique and build between the image of the fashion and the base image of the user. Now the user is able to see what they will look like wearing the fashion and will be presented with a bill of materials that comprise the fashion and links for purchasing each item in the fashion.

In one embodiment, a system for viewing and selecting wearable objects is disclosed including a device having a processor, non-transitory memory, a transceiver, means for communicating with a server computer, a way to obtaining images, a display, and device software running on the processor from the non-transitory memory. There is server software running on a server processor of the server computer. When the device obtains a base image of a user, the device sends the base image of the user to the server computer and when the server computer receives the base image of the user, the server software processes the base image of the user to create a processed base image of the user (e.g., creates a wire frame image of the user). When the device captures, obtains or receives an image of fashion, the device software sends the image of the fashion to the server computer and when the server computer receives the image of the fashion, the server software processes the image of the fashion to overlay the processed base image of the user with the fashion. The server software sends the processed base image of the user with the fashion to the device and when the device receives the processed base image of the user with the fashion, the device software displays the base image with the fashion on the display of the device.

In another embodiment, a method of viewing and selecting wearable objects is disclosed including receiving one or more retail items of fashion from one or more retailers and processing each of the one or more retail items into a knowledge database. The method includes receiving a base image of a user and processing the base image of the user to create a processed base image of the user. Now when an image of desired fashion is received, the processed base image of the user is overlayed with the image of the desired fashion to show the user how the user will look wearing the desired fashion.

In another embodiment, a system for viewing and selecting wearable objects is disclosed including a device having a processor, non-transitory memory, a transceiver, means for communicating with a server computer, a way to obtaining images, a display, and device software running on the processor from the non-transitory memory. There is server software running on a server processor of the server computer. The server software receives one or more retail items of fashion from one or more retailers and the server software processes each of the one or more retail items into a knowledge database using artificial intelligence. When the device receives a base image of a user, the device software sends the base image of the user to the server computer and when the server computer receives the base image of the user, the server software processes the base image of the user to create a processed base image of the user. Now, when the device receives an image of fashion, the device software sends the image of the fashion to the server computer and when the server computer receives the image of the fashion, the server software overlays the processed base image of the user with the image of the fashion and sends the processed base image of the user with the image of the fashion to the device. When the device receives the processed base image of the user with the image of the fashion, the device software displays the processed base image of the user with the image of the fashion on the display to show the user how the user will look wearing the fashion.

### BRIEF DESCRIPTION OF DRAWINGS

The invention can be best understood by those having ordinary skill in the art by reference to the following detailed description when considered in conjunction with the accompanying drawings in which:

FIG. 1 illustrates a user of the system for viewing and selecting wearable objects and a camera for capturing a base image of the user.

FIG. 2 illustrates a wire-frame image of the body of the user of the system for viewing and selecting wearable objects.

FIG. 3 illustrates capturing an image of a fashion that is of interest to a user of the system for viewing and selecting wearable objects.

FIG. 4 illustrates the fashion that is of interest to a user of the system for viewing and selecting wearable objects overlayed on the wireframe of the user.

FIG. 5 illustrates a data connection diagram of the system for viewing and selecting wearable objects.

FIG. 6 illustrates a schematic view of a typical cell phone used in the system for viewing and selecting wearable objects.

FIG. 7 illustrates a schematic view of a typical computer system such as a server as used in the system for viewing and selecting wearable objects.

FIG. 8 illustrates a user interface for setup of the system for viewing and selecting wearable objects.

FIG. 9 illustrates a user interface for selecting how to obtain an image of the user in the system for viewing and selecting wearable objects.

FIG. 10 illustrates a user interface for capturing an image of a user of the system for viewing and selecting wearable objects.

FIG. 11 illustrates a user interface for selecting how to obtain an image of a particular fashion in the system for viewing and selecting wearable objects.

FIG. 12 illustrates a user interface for capturing an image of a user of the system for viewing and selecting wearable objects.

FIG. 13 illustrates a user interface for showing an image of the user of the system for viewing and selecting wearable objects overlayed with the fashion.

FIG. 14 illustrates a user interface for providing purchase options for items in the fashion to the user of the system for viewing and selecting wearable objects.

FIG. 15 illustrates a schematic diagram for teaching the system for viewing and selecting wearable objects about items available from one or more retailers.

FIG. 16 illustrates a schematic diagram for processing an image having therein fashion items in the system for viewing and selecting wearable objects.

FIG. 17 illustrates a flow chart for capturing and processing of an image of the user in the system for viewing and selecting wearable objects.

FIG. 18 illustrates a flow chart processing fashion items available from retailers in the system for viewing and selecting wearable objects.

FIG. 19 illustrates a flow chart for processing an image having therein fashion items in the system for viewing and selecting wearable objects.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures.

In general, the system for viewing and selecting wearable objects (e.g., fashion) starts with a base image of the user, capturing the physique and build of the user. Later, when the user finds a fashion that interests the user, the user captures an image of the fashion (e.g., on another person, in a store display, on the television, on a mannequin, etc., and the system for viewing and selecting wearable objects superimposes the fashion on the base image of the user, adjusting for differences in physique and build between the image of the fashion and the base image of the user. Now the user is able to see what they will look like wearing the fashion and will be presented with a bill of materials that comprise the fashion and links for purchasing each item in the fashion.

Throughout this document, the term fashion refers to an overall look generated by one or more fashion items such as shoes, belts, scarves, shirts, pants, blouses, earrings, ties, jackets, handkerchiefs, pantsuit, jumpers, etc. The fashion is made up of one or more items. An example of a fashion made up of one item may be a bathing suit or a jumpsuit.

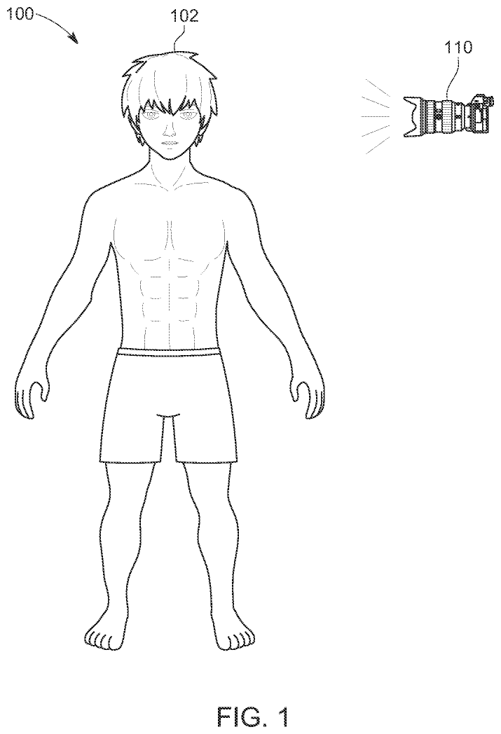

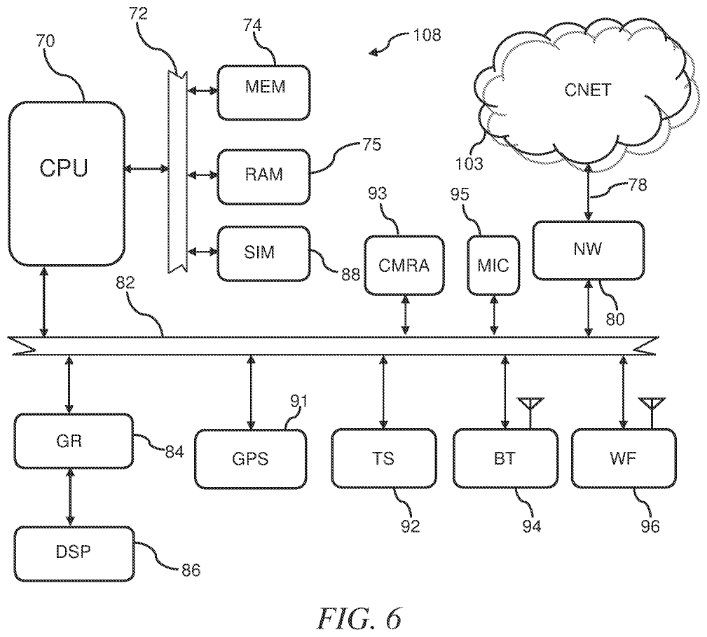

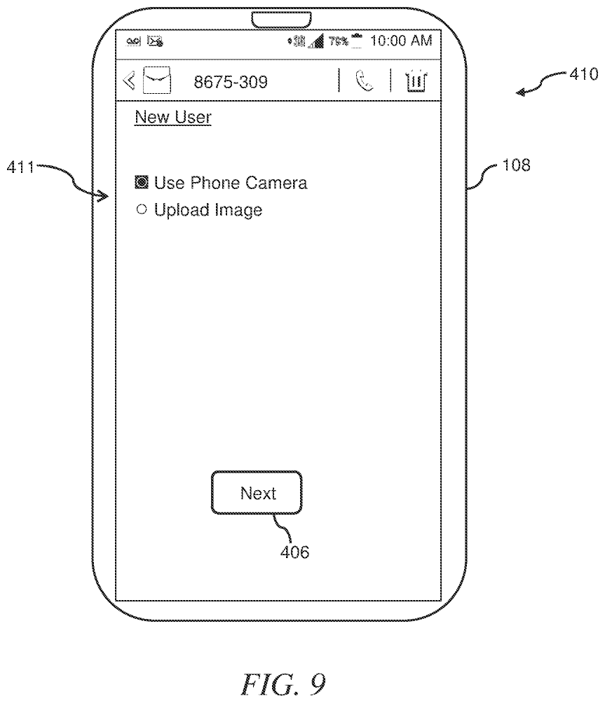

Referring to FIG. 1, a user 102 of the system for viewing and selecting wearable objects and a stand-alone camera 110 for capturing a base image 431 (see FIG. 9) of the user 102 is shown. In this view 100, the user 102 is wearing only underwear and a stand-along camera 110 is taking an image of the user 102 that will be used as the base image 431 (see FIG. 9). Although the user 102 is using a stand-alone camera 110 to obtain a base image 431 (see FIG. 9), any source of an image of the user 102 is anticipated, including, but not limited to, taking a picture of the user 102 using the camera 93 (see FIG. 6) of the smartphone 108. In some scenarios, the user 102 has another person take their picture or captures their picture in any way known, for example, taking a selfie, using a selfie stick, using a tripod, resting the smartphone 108 on a surface, etc.

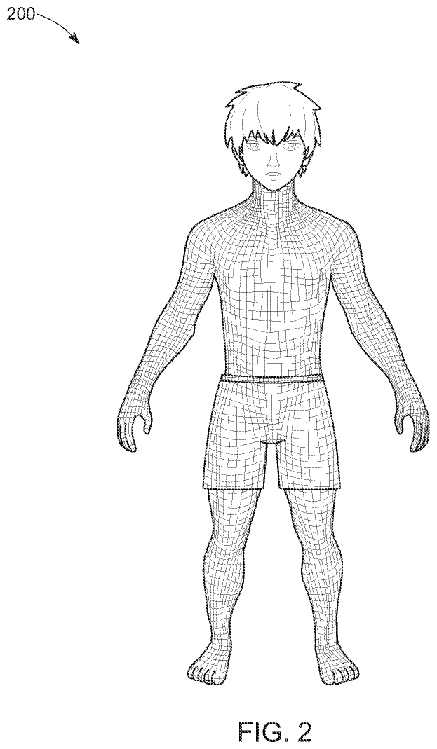

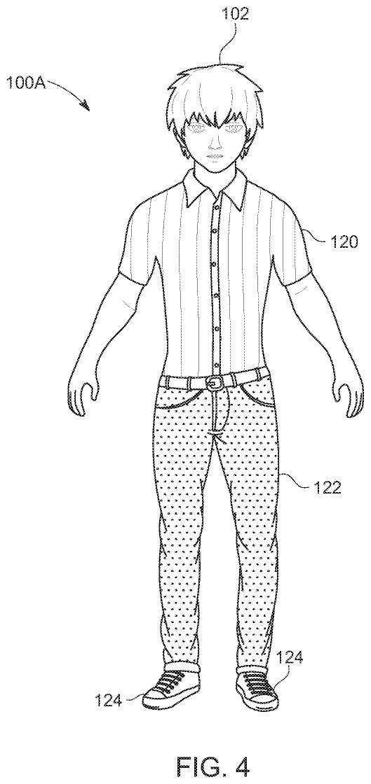

Referring to FIG. 2, a wire-frame image 200 of the body of the user of the system for viewing and selecting wearable objects is shown. The base image 431 that was captured or obtained in FIG. 1 is processed by either the smartphone 108, transferred to the server computer 500 and processed by the server computer 500, or both. The base image 431 is processed to create a processed base image 1431 that is ready for fashion to be superimposed thereon. Therefore, it is preferred, though not required, that the user 102 be wearing minimal clothing in order to create a base image that follows the size and contours of the user 102. Although shown as a wire-frame image 200, there is no specific limitation that the processed base image 1431 be a wireframe, only that the processed base image 1431 is normalized to permit overlay of fashion items as will be shown in FIG. 4.

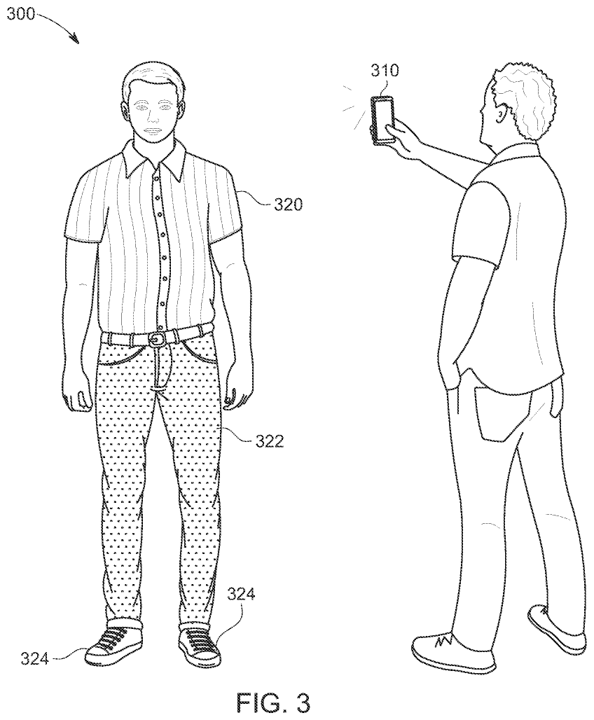

Referring to FIG. 3, capturing an image of a fashion that is of interest to a user 102 of the system for viewing and selecting wearable objects is shown. In this example, a person or manikin 300 is wearing a particular fashion. Someone is taking a picture of the person or manikin 300 using another smartphone 310. In another example, the user 102 aims the camera 93 of the smartphone 108 at the person or manikin 300 or any other source of a particular fashion, including taking a picture or obtaining a picture of a single item such as a shirt on a hangar. In this example, the person or manikin 300 is wearing a striped shirt 320, polka dot pants 322 and sneakers 324. The user 102 is interested in seeing how the user 102 would look wearing this fashion and, therefore, the user 102 obtains an image of the fashion of interest in any way known in the industry.

Referring to FIG. 4, the fashion that is of interest to a user 102 of the system for viewing and selecting wearable objects overlayed on the wireframe 200 of the user 102. In this, the fashion from the image of the fashion as was being worn by the person or manikin of FIG. 3 is now overlayed onto the processed base image 1431 of the user 102 showing the user 102 a view 100A of the user 102 wearing each item of the fashion. Note that the items of the fashion such as the shirt 320, the polka dot pants 322, and the sneakers 324 have been processed to scale each item to the body/physique of the user 102. Therefore, the processed shirt 120, processed pants 122, and processed sneakers 124 have been resized to match the body/physique of the user 102.

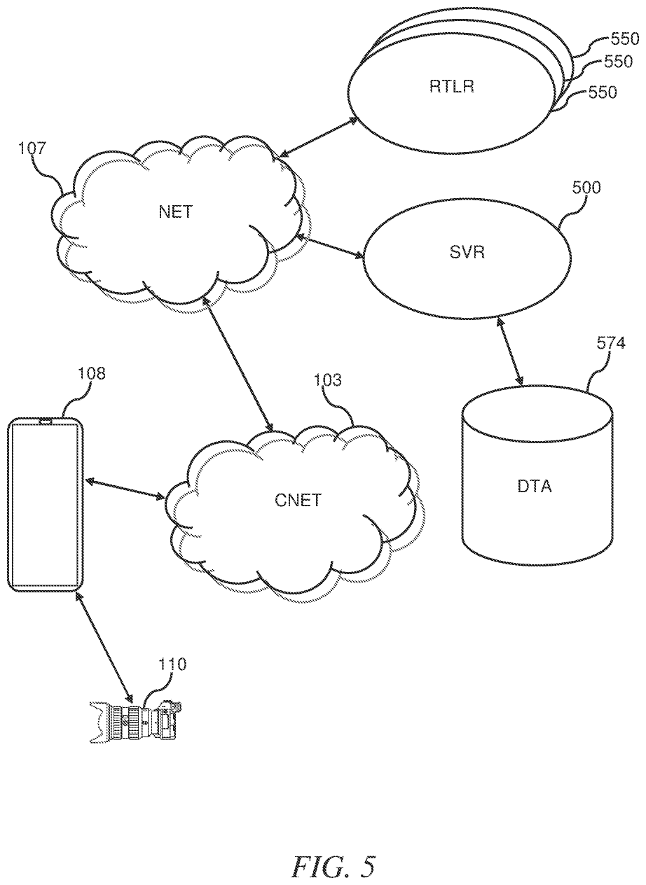

Referring to FIG. 5 illustrates a data connection diagram of the system for viewing and selecting wearable objects. In this example, a stand-alone camera 110 is shown in communications with a smartphone 108, though it is equally anticipated that any image capturing device be used in the system for viewing and selecting wearable objects including the camera 93 of the smartphone 108, a scanner, etc. It is fully anticipated that any processor-based device be used by the user for using the system for viewing and selecting wearable objects. Throughout this document, a smartphone 108 is used as an example of a processor-based device, though any processor-based device or combination thereof is anticipated. Examples of processor-based devices include personal computers, notebook computers, tablet computers, and smart watches.

The smartphone 108 (or any processor-based device used by the user) communicates with a server computer 500 (dedicated server or cloud-based server) by way of any network topology, either known or future. In the example shown in FIG. 1, the smartphone 108 communicates through the cellular network 103 and/or through a wide area network 107 (e.g., the Internet) to the server computer 500.

In embodiments in which a stand-alone camera 110 is used, it is assumed that images captured by the stand-alone camera 110 are transferred to the smartphone 108, either by a wireless connection or a wired connection. As needed, the images are then uploaded to the server computer 500 and stored in data storage 574 and/or manipulated by the server computer 500.

The server computer 500 has access to data storage 574 for storing various data, including images received from the smartphone 108 of the user. Although one path between the smartphone 108 and the server computer 500 is through the cellular network 103 and the wide area network 107 as shown, any known data path is anticipated. For example, the Wi-Fi transceiver 96 (see FIG. 2) of the smartphone 108 is used to communicate directly with the wide area network 107, which includes the Internet, and, consequently, with the server computer 500.

The server computer 500 transacts with the smartphone 108 through the network(s) 103/107 to present user interfaces on the display 86 (see FIG. 6) of the smartphone 108, to exchange images, and to communicate information such as where certain objects of the sought after fashion can be purchased.

The server computer 500 transacts with an application running on the smartphone 108 and/or with standardized applications (e.g., browsers) running on the smartphone 108.

Note that although a single smartphone 108 is shown in the drawings, there is no limitation as to the number of smartphones 108 (or other local devices). Likewise, although the server computer 500 is shown as a single computer, it is fully anticipated that multiple computers operate in cooperation to provide the server functionality.

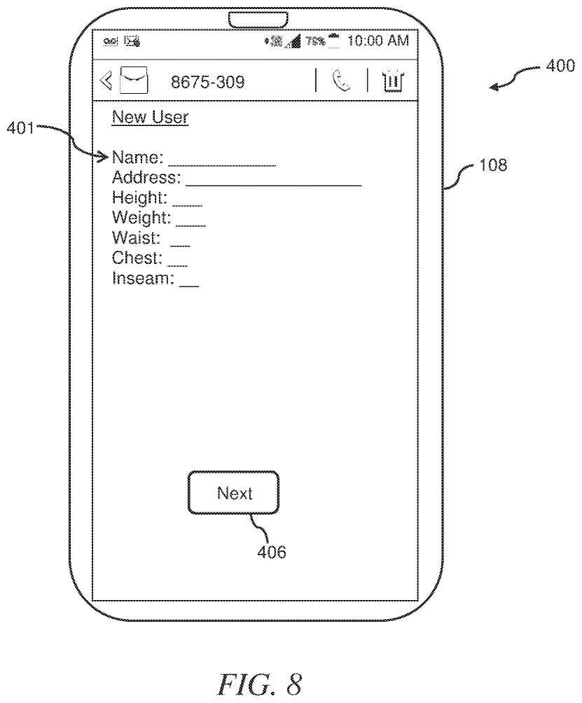

Referring to FIG. 5, a schematic view of a smartphone 108 is shown. The example smartphone 108 represents a typical phone device used for accessing user interfaces (e.g., see FIGS. 8 through 14) of the system for viewing and selecting wearable objects. This exemplary smartphone 108 is shown in a typical form. Different architectures are known that accomplish similar results in a similar fashion and the present invention is not limited in any way to any particular smartphone 108 system architecture or implementation. In this exemplary smartphone 108, a processor 70 executes or runs programs in a random-access memory 75. The programs are generally stored within a persistent memory 74 and loaded into the random-access memory 75 when needed. Also accessible by the processor 70 is a SIM card 88 (subscriber information module) having a subscriber identification. The processor 70 is any processor, typically a processor designed for phones. The persistent memory 74, random access memory 75, and SIM card are connected to the processor, for example, by a memory bus 72. The random-access memory 75 is any memory suitable for connection and operation with the selected processor 70, such as SRAM, DRAM, SDRAM, RDRAM, DDR, DDR-2, etc. The persistent memory 74 is any type, configuration, capacity of memory suitable for persistently storing data, for example, flash memory, read only memory, battery-backed memory, etc. In some smartphones 108, the persistent memory 74 is removable, in the form of a memory card of appropriate format such as SD (secure digital) cards, micro-SD cards, etc.

Also connected to the processor 70 is a system bus 82 for connecting to peripheral subsystems such as a cellular network interface 80, a graphics adapter 84 and a touch screen interface 92. The graphics adapter 84 receives commands from the processor 70 and controls what is depicted on a display image on the display 86. The touch screen interface 92 provides navigation and selection features.

In general, some portion of the persistent memory 74 and/or the SIM card 88 is used to store programs, executable code, images, contacts, and data, etc. In some embodiments, other data is stored in the persistent memory 74 such as audio files, video files, text messages, etc.

The peripherals are examples and other devices are known in the industry such as Global Positioning Subsystem 91, speakers, microphones, USB interfaces, Bluetooth transceiver 94, Wi-Fi transceiver 96, camera 93, microphone 95, image sensors, etc., the details of which are not shown for brevity and clarity reasons.

The cellular network interface 80 connects the smartphone 108 to the cellular network 103 through any cellular band and cellular protocol such as GSM, TDMA, LTE, etc., through a wireless medium 78. There is no limitation on the type of cellular connection used. The cellular network interface 80 provides voice call, data, and messaging services to the smartphone 108 through the cellular network.

For local communications, many smartphones 108 include a Bluetooth transceiver 94, a Wi-Fi transceiver 96, or both. Such features of the smartphone 108 provide data communications between the smartphone 108, the dedicated camera 110, and the server computer 500.

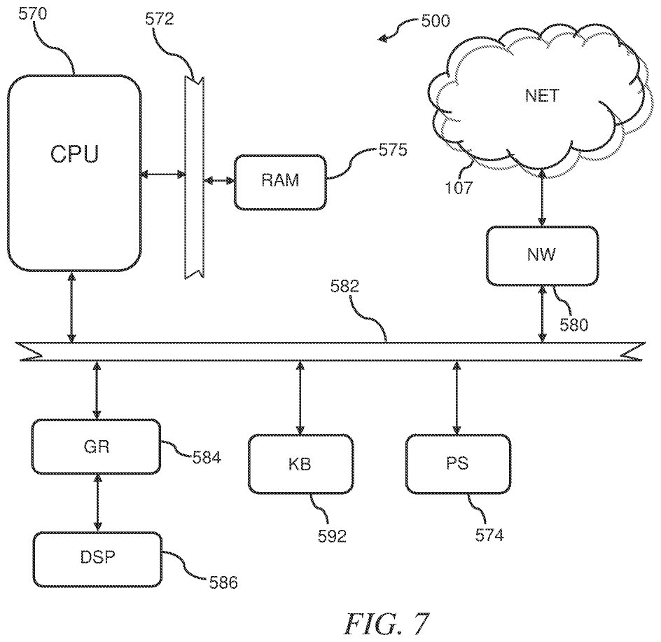

Referring to FIG. 7, a schematic view of a typical computer (e.g., server computer 500) is shown. The example computer system represents a typical computer system used for back-end processing, generating reports, displaying data, etc. This server computer 500 is shown in its simplest form as different architectures are known that accomplish similar results in a similar or different fashion and the present invention is not limited in any way to any particular computer system architecture or implementation. In some embodiments, the server computer 500 is part of an array of server computers and in some embodiments, a cloud computing resource.

In this exemplary computer system, a processor 570 executes or runs programs in a random-access memory 575. The programs are generally stored within a persistent memory (data storage 574) and loaded into the random-access memory 575 when needed. The processor 570 is any processor, typically a processor designed for computer systems with any number of core processing elements, etc. The random-access memory 575 is connected to the processor by, for example, a memory bus 572. The random-access memory 575 is any memory suitable for connection and operation with the selected processor 570, such as SRAM, DRAM, SDRAM, RDRAM, DDR, DDR-2, etc. The persistent memory (data storage 574) is any type, configuration, capacity of memory suitable for persistently storing data, for example, magnetic storage, flash memory, read only memory, battery-backed memory, magnetic memory, etc. The persistent memory (data storage 574) is typically interfaced to the processor 570 through a system bus 582, or any other interface as known in the industry.

Also shown connected to the processor 570 through the system bus 582 is a network interface 580 (e.g., for connecting to a data network 107), an optional graphics adapter 584 and a keyboard interface 592 (e.g., Universal Serial Bus—USB). The graphics adapter 584 receives commands from the processor 570 and controls what is depicted on a display image on the display 586. The keyboard interface 592 provides navigation, data entry, and selection features.

In general, some portion of the persistent memory (data storage 574) is used to store programs, executable code, images, user data, and other data, etc.

The peripherals are examples and other devices are known in the industry such as speakers, microphones, USB interfaces, Bluetooth transceivers, Wi-Fi transceivers, image sensors, temperature measuring devices, etc., the details of which are not shown for brevity and clarity reasons.

Referring to FIG. 8, an exemplary smartphone user interface 400 of the system for viewing and selecting wearable objects is shown. Although many user interfaces are anticipated, one example user interface is a text input interface that is used to gather data from a user when they first start using the system for viewing and selecting wearable objects.

Demographic information 401 is gathered from the user 102, for example, the name of the user 102, address of the user 102, and any other data that is useful in improving the accuracy of the system for viewing and selecting wearable objects such as specific body measurements if known by the user 102. It should be noted that there is no requirement for providing any of the specific body measurements as the system for viewing and selecting wearable objects will operate without having any specific body measurements. The specific body measurements are useful in the ordering processes, as it is difficult to determine body measurements of the user 102 by solely taking a picture of the user 102, For example, the user 102 of FIG. 1 has a certain stature, but it is entirely possible that this user is 5 foot tall with a 28-inch waist or 6 foot tall with a 36-inch waist. As will be seen, the system for viewing and selecting wearable objects will provide purchasing options and, either in the user interface of FIG. 8 or when purchasing, the user 102 will need to add their measurements.

Once the user 102 finishes entering the information, the user invokes the “Next” function 406 and the information is saved and/or forwarded to the server computer 500 for storage in the data storage 574.

Referring to FIG. 9, a second exemplary smartphone user interface 410 of the system for viewing and selecting wearable objects is shown. Although many user interfaces are anticipated, one example user interface is a display interface that is used to capture an image of the user 102 for use by the user of the system for viewing and selecting wearable objects as a base image.

In some embodiments, the user 102 can select a source of the base image in the user interface 410, The user has directives 411 to select the camera 93 of the smartphone 108 or the user 102 can upload an image, for example, from the stand-alone camera 110. In this example, the user 102 has selected use of the camera 93 of the smartphone 108. When done selecting, the user selects the “Next” function 406 and the base image capture user interface 430 appears. In this example, the user 102 has another person take their picture or any way known for the user 102 to capture an image of themselves, for example, taking a selfie, using a selfie stick, using a tripod, resting the smartphone 108 on a surface, etc. In the base image capture user interface 430, the base image 421 is shown and there is a capture directive 426. When the user (or whoever is taking the base image) presses the capture directive 426, the base image 431 is captured and processed by either the smartphone 108, transferred to the server computer 500 and processed by the server computer 500, or both. The base image 431 is processed to create a processed base image 1431 that is ready for fashion to be superimposed thereon. Therefore, it is preferred, though not required, that the user 102 be wearing minimal clothing in order to create a base image that follows the size and contours of the user 102.

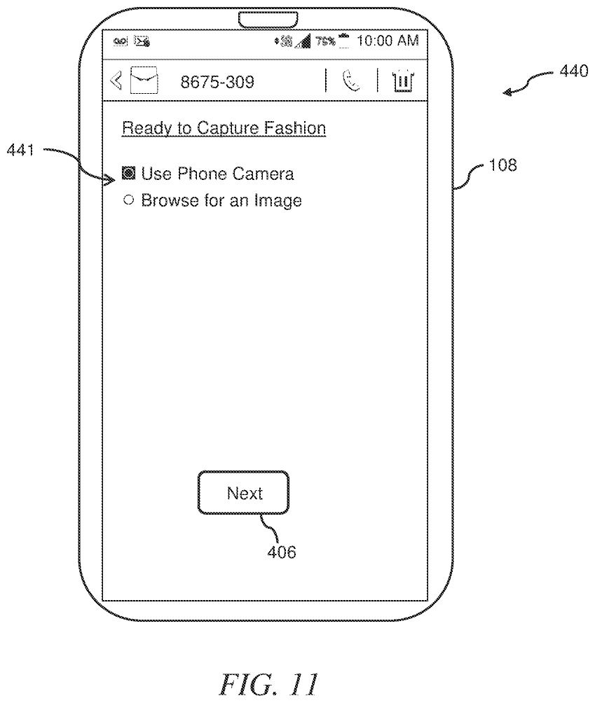

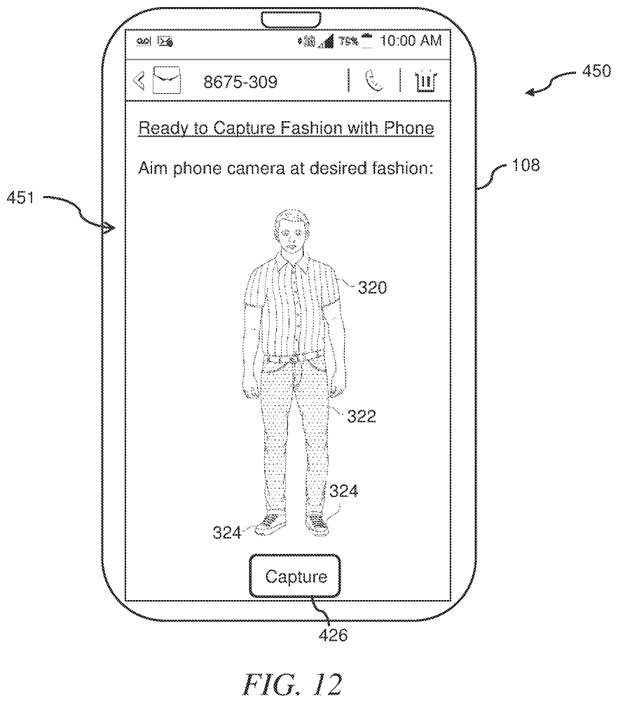

At any time after the base image 431 is captured, the user 102 accesses the fashion capture user interface 440 as in the example of FIG. 11. When the user 102 sees a fashion of which they are interested, for example, the user 102 sees someone in a magazine, sees someone on the television, sees someone on their computer, sees someone out in public, and the user 102 wants to see how the user 102 will look with that fashion, the user 102 navigates to the fashion capture user interface 440. Again, in some embodiments, the user 102 has selection directives 441 to determine a source of an image of the fashion. In this example, the user 102 is presented with selection directives 441 for using the camera 93 of the smartphone 108 or to browse for an existing image that the user captured previously or came from another device such as the stand-alone camera or downloaded from the Internet. After the user 102 uses the selection directives 441 to select (in this example, the user 102 selects that the camera 93 of the smartphone 108 be used), the user invokes the “Next” function 406 and the second fashion capture user interface 450 of FIG. 12 is shown.

In this example 451, the user 102 is aiming the camera 93 of the smartphone 108 at a person wearing a striped shirt 320, polka dot pants 322 and sneakers 324. As the user 102 is interested in seeing how the user 102 would look wearing this fashion, the user 102 operates the capture directive 426 to capture an image of the fashion of interest.

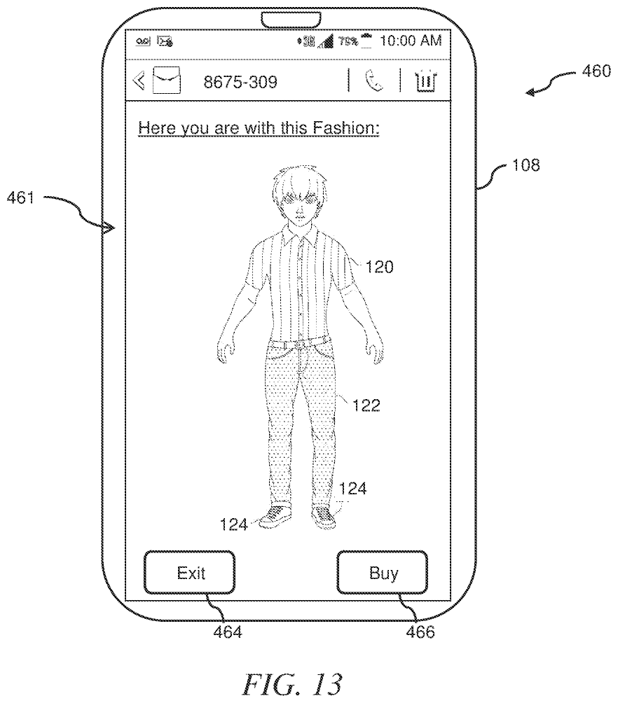

In FIG. 13, in this user interface 460, the system for viewing and selecting wearable objects has superimposed the fashion that was just captured over the processed base image 1431 and the user 102 has an image 461 of the user's body wearing the striped shirt 120, polka dot pants 122 and sneakers 124 from the fashion image that was captured.

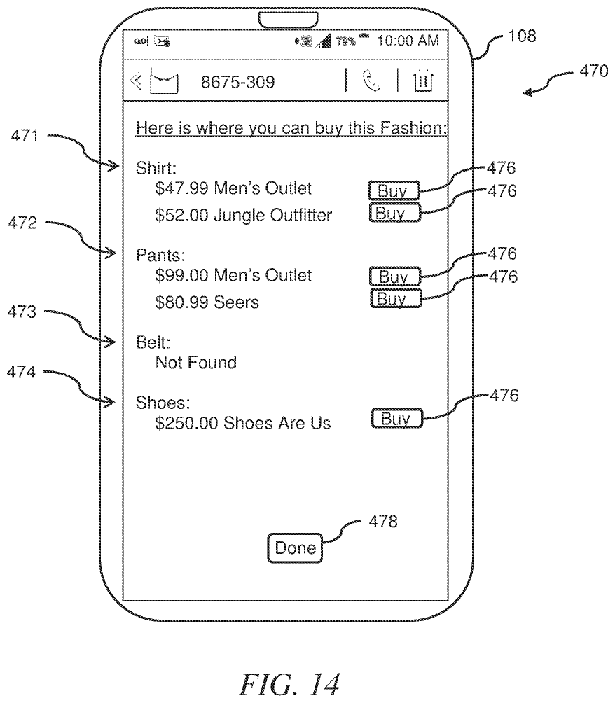

If the user is not interested in duplicating any part of this fashion, the user operates the exit directive 464. If the user is interested in duplicating part of all of this fashion, the user operates the buy directive 466 and proceeds to a purchase user interface 470 as in FIG. 14. In this, the system for viewing and selecting wearable objects has pattern matched each item of the fashion (e.g., the shirt 320, the polka dot pants, 322, the belt, and the sneakers 324) to similar objects that are available from one or more retailers 550. For example, the system for viewing and selecting wearable objects has found the shirt 320 in two different retailers 550 as in the shirt section 471, the system for viewing and selecting wearable objects has found the polka dot pants 322 in two different retailers 550 as in the pants section 472, the system for viewing and selecting wearable objects was unable to find the belt at any retailer 550 as in the belt section 473, and the system for viewing and selecting wearable objects has found the sneakers 324 in one retailer 550 as in the shoes section 474. Next to each item that was found is a buy directive 476. Operation of the buy directive 476 will either open a browser to a page on the associated retailer's web site at which the user 102 is able to purchase the item or will add the item to a shopping cart so that, when the user is ready, the user 102 is able to visit the shopping cart and purchase all desired items with a single purchase.

Note that in some embodiments of the system for viewing and selecting wearable objects, use of the system for viewing and selecting wearable objects is paid for or subsidized by one or more retailers 550 that provide access to their catalogs in exchange for access to additional potential clients through the system for viewing and selecting wearable objects. In other embodiments, the system for viewing and selecting wearable objects is a service paid for by the user 102 and, in some cases, subsidized by one or more retailers 550. For completeness, there is a done directive 478.

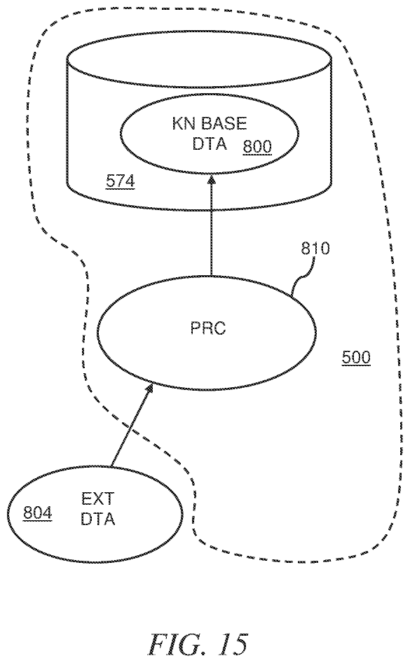

Referring to FIG. 15, an exemplary learning implementation of the system for viewing and selecting wearable objects that uses a mathematical process 810 represented by, for example, a simplified multilayer feed-forward neural network is shown. Although the algorithms of the system for viewing and selecting wearable objects are anticipated to be implemented using finite state machines, heuristics, or any programing paradigm, in the embodiment shown, artificial intelligence is utilized to receive catalogs from one or more retailers 550 (external data 804) and populate the knowledge base 800 with knowledge that will be used to find various items that are of interest to the user 102. As an example, as a catalog of the retailer 550 is received at the server computer 500, a first item from the catalog is a shirt. The mathematical process 810 recognizes that the item and saves data about the item in the knowledge base 800. The data includes a type of the item (a shirt), the colors of the item (either from a picture of the shirt and/or color choices from the catalog), sizes that are available (e.g., from the catalog), color patterns and features of the item (e.g., solid color, horizontal stripes, vertical stripes, diagonal stripes, thickness of stripes, polka dots, objects like palm trees or animals, button patterns, seam patterns, sleeve style, collar style etc. The system for viewing and selecting wearable objects does this for all items in the retailer's catalog(s) and for all retailers 550 desired, populating the knowledge base 800 with knowledge regarding a magnitude of fashion items that are available from one or more retailers 550.

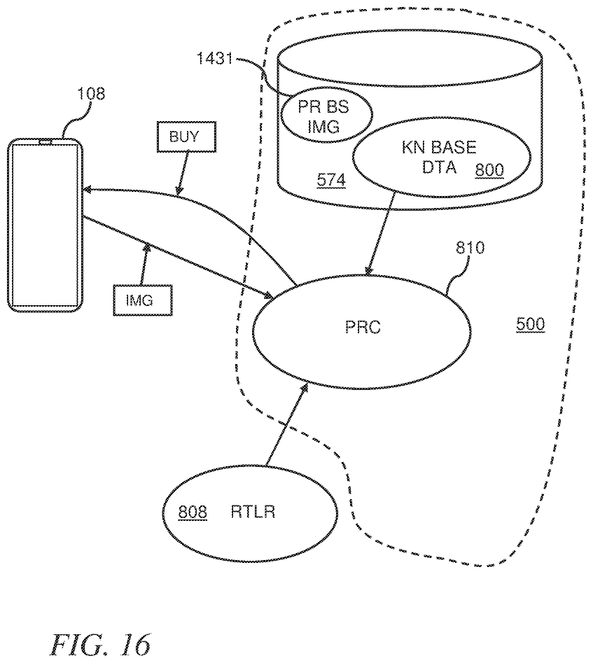

Referring to FIG. 16, an exemplary usage implementation of the system for viewing and selecting wearable objects is shown. Again, in this example, the system for viewing and selecting wearable objects uses a mathematical process 810 represented by a simplified multilayer feed-forward neural network, hereafter referred to as the neural network 810, though as discussed above, any programming paradigm is anticipated, including, but not limited to, finite state machines, heuristics, or any programing paradigm.

The server computer 500 receives an image of the fashion from the smartphone 108 of the user 102, as for example, captured as discussed in FIG. 12. The image of the fashion is processed by the mathematical process 810 which accesses the knowledge base 800 to find (if available) each item in the fashion that is available from any of the retailers 550 that have supplied catalogs (e.g., external data 808). After all items in the fashion are processed by the mathematical process 810, each item in the fashion that is available from one or more of the retailers 550 is added to a buy transaction that is sent back to the smartphone 108 (e.g., user device). When the user 102 selects a buy directive 476 (see FIG. 14), the smartphone 108 communicates directly with the retailer 808 or indirectly with the retailer 550 through the server computer 500.

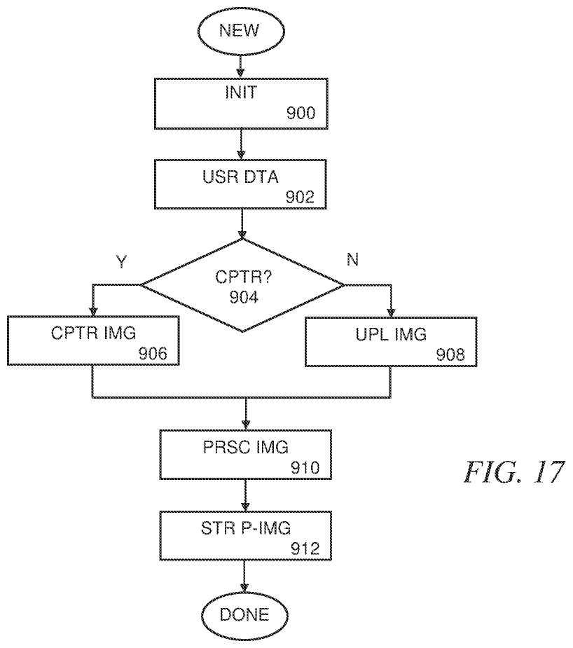

Referring to FIG. 17, an exemplary new user flowchart of the system for viewing and selecting wearable objects is shown. It should be noted that some or all of the processing shown in the flowcharts is performed at the user device (e.g., smartphone 108) and/or some or all of the processing shown in the flowcharts is performed at the server computer 500.

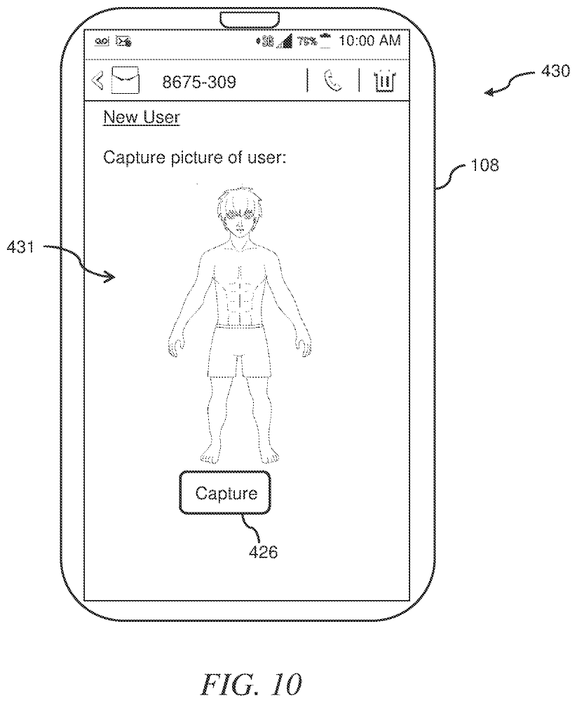

After initialization 900, user data is read 902 and stored (e.g., in data storage 574). The user data includes user sizes and measurements that will be used later in making purchases of one or more fashion items. Next, the user 102 selects how the image of the user 102 (base image 431) is to be obtained 904, either captured or uploaded from an existing file. If the user 102 selects captured, the base image is captured 906 as in FIG. 10. Alternately, if the user selects upload, the image is uploaded 908, for example, from an existing file stored at the smartphone 108.

However the base image 431 of the user 102 is obtained, the base image 431 is now processed 910 into the processed base image 1431. As an example of this, the image is processed 910 to convert the image into a wireframe model as shown in FIG. 2. Any known or future processing of the base image 431 into the processed base image 1431 is anticipated, the net result being a processed base image 1431 that is ready to be overlayed with fashion items as in FIG. 13. The processed image is stored 912 in the data storage 574.

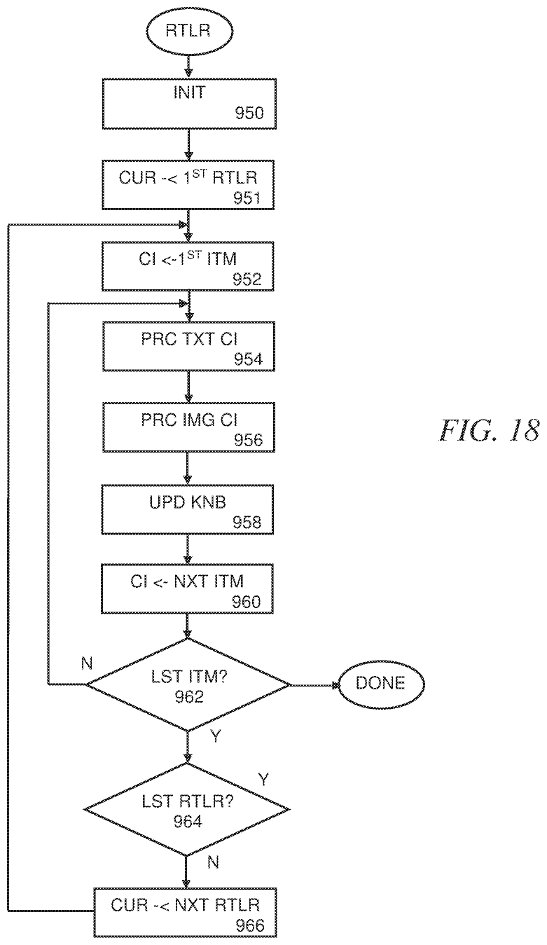

Referring to FIG. 18, an exemplary retailer processing flowchart of the system for viewing and selecting wearable objects is shown. Again, it should be noted that some or all of the processing shown in the flowcharts is performed at the user device (e.g., smartphone 108) and/or some or all of the processing shown in the flowcharts is performed at the server computer 500.

After initialization 950, a first retailer 550 is selected 951 as the current retailer 550 (CI) and a loop begins to process a catalog of the current retailer 550. In the loop, the current item (CI) is set to the first item 952 of the current retailer 550 is selected. In a sub loop the text of the current item is processed 954 (e.g., using AI or heuristics to find and extract details such as cost, size(s), color(s), measurements, features). Next, the image associated with the current item is processed 956 (e.g., using AI or heuristics to find and extract details such as color(s), patterns, features). Next the knowledge base 800 is updated 958 with the details of the current item, allowing for later searching to find the current item. The current item is set to the next item 960. If this is not the last item 962 in the current retailer's catalog, the inner loop repeats. If the current item is the last item 962 in the current retailer's catalog, it is determined 964 if this is the last retailer 550. If the current retailer is the last 964 retailer 550, then the retailer processing is done. If the current retailer 550 is not the last retailer 964, then the current retailer 550 is set to the next retailer 966 and the outer loop continues.

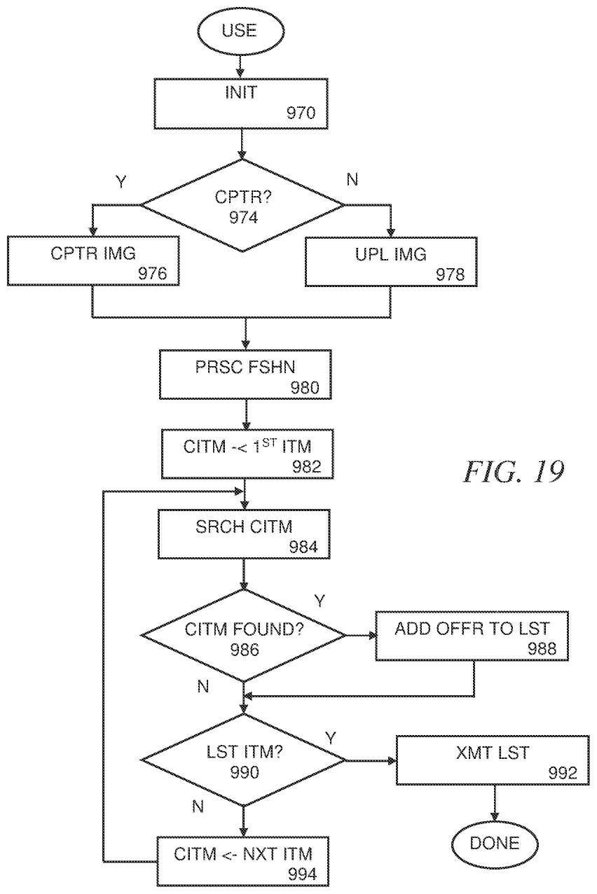

Referring to FIG. 19, an exemplary fashion processing flowchart of the system for viewing and selecting wearable objects is shown. Again, it should be noted that some or all of the processing shown in the flowcharts is performed at the user device (e.g., smartphone 108) and/or some or all of the processing shown in the flowcharts is performed at the server computer 500.

After initialization 970, the user 102 selects how the image of the fashion is to be obtained 974, either captured or uploaded from an existing file. If the user 102 selects captured, the image of the fashion is captured 976 as in FIG. 12. Alternately, if the user selects upload, the image of the fashion is uploaded 978, for example, from an existing file stored at the smartphone 108.

Now the image of the fashion is processed 980 (e.g., using AI or heuristics) to extract each item of fashion in the image of the fashion (e.g., a shirt, trousers, shoes, belt, earing, cufflink, watch, jacket, tie, scarf) and for each item, to determine features such as color(s), patterns (e.g., stripes, repeated objects such as trees, fish, paisley), button patterns, stitching patterns, material (e.g., corduroy), etc.).

Next, the current item is set 982 to a first item that was extracted when the image of the fashion was processed 980 and a loop begins. In the loop, the current item (CITM) searched 984 in the knowledge base using the mathematical process 810 represented by, for example, a simplified multilayer feed-forward neural network is shown. Although the algorithms of the system for viewing and selecting wearable objects are anticipated to be implemented using finite state machines, heuristics, or any programing paradigm. If the current item (CITM) is found 986 (e.g., the current item is found from at least one retailer 550), the offer from the retailer 550 is added to the a list 988 (note it is fully anticipated that the current item be found 986 from multiple retailers 550 or several items from the same retailer 550 and being that the mathematical process 810 is anticipated to be a fuzzy process, closest matches are found 986. For example, if the current item is a shirt having a solid color of pink and 7 buttons, there may be no exact matches, but several offers are found for shirts having a solid color of pink and 6 or 8 buttons, each of which is added to the list 988.

Now, if the current item is the last item 990, the list is transmitted 992 (or displayed) for the user 102 to see and possibly purchase from the retailers 550. If the current item is not the last item 990, the current item is set to the next item 994 and the loop continues.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction, and arrangement of the components thereof without departing from the scope and spirit of the invention or without sacrificing all of its material advantages. The form herein before described being merely exemplary and explanatory embodiment thereof. It is the intention of the following claims to encompass and include such changes.

1. A system for viewing and selecting wearable objects, the system comprising:
a smartphone having a processor, non-transitory memory, a transceiver, means for communicating with a server computer, means for obtaining images, a display, and device software running on the processor from the non-transitory memory;
a server computer having a server processor and a non-transitory computer-readable data storage media operatively interface to the server processor;
server software running on the server processor of the server computer from the non-transitory computer-readable data storage media;
when the smartphone has obtained a base image of a user, the smartphone sends the base image of the user to the server computer and when the server computer receives the base image of the user, the server software processes the base image of the user to create a processed base image of the user;
when the smartphone captures an image of fashion using the means for obtaining images, the smartphone software sends the image of the fashion to the server computer and when the server computer receives the image of the fashion, the server software processes the image of the fashion to overlay the processed base image of the user with the fashion; and
the server software sends the processed base image of the user with the fashion to the smartphone and when the smartphone receives the processed base image of the user with the fashion, the smartphone software displays the base image with the fashion on the display of the smartphone.

2. The system for viewing and selecting wearable objects of claim 1, wherein the means for obtaining the images is a camera integrated into the smartphone.

3. The system for viewing and selecting wearable objects of claim 1, wherein the means for obtaining the images is a standalone camera and the standalone camera transfers the images to the smartphone by either a wired or a wireless transmission medium.

4. The system for viewing and selecting wearable objects of claim 1, wherein the processed base image of the user is a wireframe version of the base image of the user.

5. The system for viewing and selecting wearable objects of claim 1, wherein the server software receives retail items of fashion from one or more retailers and the server software analyzes and catalogs each of the retail items of the fashion into a knowledge database and when the server software sends the processed base image of the user with the fashion to the smartphone for display of the base image with the fashion on the display of the smartphone, the server software extracts items of fashion from the image of the fashion and for each of the items of the fashion from the image of the fashion, the server software searches the knowledge database for a matching retail item of the fashion and the server software sends an entry of each matching retail item of the fashion to the smartphone to be displayed on the display of the smartphone.

6. The system for viewing and selecting wearable objects of claim 5, wherein the smartphone software displays the entry of each matching retail item on the display of the smartphone, the smartphone software accepts order requests for one or more of the each matching retail item.

7. The system for viewing and selecting wearable objects of claim 6, wherein after the smartphone software receives an order request for one or more of the each matching retail item, the smartphone software initiates an order of one or more of the each matching retail item from one or more of the one or more retailers.

8. A computerized method being implemented via execution of computing instructions to run on one or more processors and stored at one or more non-transitory computer-readable media, the computerized method comprising:
receiving one or more retail items of fashion from one or more retailers;
processing each of the one or more retail items into a knowledge database;
receiving a base image of a user;
processing the base image of the user to create a processed base image of the user;
the user capturing an image of desired fashion using a digital camera; and
overlaying the processed base image of the user with the image of the desired fashion to show the user how the user will look wearing the desired fashion.

9. The computerized method of claim 8, further comprising: processing the image of the fashion to extract fashion items from the image of the fashion.

10. The computerized method of claim 9, further comprising: for each fashion item in the fashion items, searching the knowledge database for one or matching retail items of the fashion.

11. The computerized method of claim 10, further comprising: for each matching retail item of the fashion, displaying the each matching retail item of the fashion along with a directive for purchasing the each matching retail item of the fashion from one or more of the one or more retailers.

12. The computerized method of claim 11, further comprising: upon invoking the directive for purchasing the each matching retail item of the fashion from one of the one or more retailers, purchasing the each matching retail item of the fashion from the one of the one or more retailers.

13. The computerized method of claim 8, wherein the processing each of the one or more retail items into the knowledge database comprises an artificial intelligence engine that extracts details of each of the one or more retail items into the knowledge database.

14. The computerized method of claim 13, wherein the details of each of the one or more retail items comprise one or more of colors of the one or more retail items, sizes of the one or more retail items, cost of the one or more retail items, and style elements of the one or more retail items.

15. A computer program product comprising: one or more non-transitory computer-readable data storage media; computing instructions stored on the one or more non-transitory computer-readable data storage media and executable by one or more processors to perform:
receiving one or more retail items of fashion from one or more retailers and processing each of the one or more retail items into a knowledge database using artificial intelligence;
capturing a base image of a user and;
processing the base image of the user to create a processed base image of the user;
after the user capturing an image of fashion using a camera overlaying the processed base image of the user with the image of the fashion displaying the processed base image of the user with the image of the fashion on the display to show the user how the user will look wearing the fashion.

16. The computer program product of claim 15, further comprising:
when the server computer receives the image of the fashion, the server software processes the image of the fashion to extract fashion items from the image of the fashion.

17. The computer program product of claim 16, further comprising:
for each fashion item in the fashion items, the server software searches the knowledge database for one or more matching retail items of the fashion.

18. The computer program product of claim 17, further comprising:
the server software transmits each of the one or more matching retail items of the fashion to the device and when each of the one or more matching retail items of the fashion to is received at the device, the device software displays each of the one or more matching retail items of the fashion along with a directive for purchasing the each matching retail item of the fashion from one or more of the one or more retailers.

19. The computer program product of claim 18, further comprising:
upon one directive for purchasing being activated, a transaction is sent to one of the one or more retailers requesting a purchase of the matching retail item of the fashion from the one or more of the retailers.

20. The computer program product of claim 15, wherein the device is a smartphone.
